(19) United States
(12) Patent Application Publication
(10) Pub. No.: US 2023/0112680 A1
(43) Pub. Date: Apr. 13, 2023

(54) PROXY-SERVICE MESSAGE TRANSLATION AND SECURITY

(71) Applicant: ARRIS Enterprises LLC, Suwanee, GA (US)

(72) Inventor: Che-Kuan Chao, Taipei (TW)

(73) Assignee: ARRIS Enterprises LLC, Suwanee, GA (US)

(21) Appl. No.: 17/959,421

(22) Filed: Oct. 4, 2022

Related U.S. Application Data
(60) Provisional application No. 63/253,263, filed on Oct. 7, 2021.

(51) Int. Cl. H04L 67/146; H04L 43/067; H04L 67/02; H04L 67/133

(52) U.S. Cl. CPC H04L 67/146; H04L 43/067; H04L 67/02; H04L 67/133

(57) ABSTRACT

A computer system that processes state messages is described. During operation, the computer system may receive, associated with communication network devices in a network, the state messages, where the state messages include report messages and event messages. Then, the computer system may validate the state messages based at least in part on tokens associated with the state messages. Moreover, the computer system may provide the report messages to one or more first consumers in the computer system. Furthermore, the computer system may select a subset of the event messages based at least in part on a type of event. Next, the computer system may translate the selected subset of the event messages from a first format to a second format. Additionally, the computer system may provide the translated subset of the event messages to one or more second consumers.

### CROSS REFERENCE TO RELATED APPLICATIONS

This application claims priority under 35 U.S.C. 119(e) to U.S. Provisional Application Ser. No. 63/253,263, “Proxy-Service Message Translation and Security,” filed on Oct. 7, 2021, by Che-Kuan Chao, the contents of which are herein incorporated by reference.

### FIELD

The described embodiments relate to techniques for processing state messages from communication network devices.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

In an enterprise Wi-Fi network, there is typically a controller that manages communication network devices (such as access points, switches and/or routers), e.g., by providing configuration management, user authentication, events/alarms reports, statistics reports, and/or monitors access-point functions. For example, a given communication network device may periodically report statistics and/or events (which are collectively sometimes referred to as ‘state messages’) to a controller. Consequently, in large deployments, with multiple communication network devices, there will be multiple periodic state messages reported to the controller.

However, it may be difficult to process large numbers of state messages in a controller. Moreover, modifying the processing of state messages by a controller may be complicated, which include the expense and the time needed to implement changes.

### SUMMARY

A computer system that processes state messages is described. This computer system may include an interface circuit that communicates with communication network devices (such as one or more access points, one or more switches and/or one or more routers) in a network. During operation, the computer system receives, associated with the communication network devices, the state messages, where the state messages include report messages and event messages. Then, the computer system validates the state messages based at least in part on tokens associated with the state messages. Moreover, the computer system provides the report messages to one or more first consumers in the computer system. Furthermore, the computer system selects a subset of the event messages based at least in part on a type of event. Next, the computer system translates the selected subset of the event messages from a first format to a second format. Additionally, the computer system provides the translated subset of the event messages to one or more second consumers.

Note that the one or more first consumers or the one or more second consumers may include an analytical service. Alternatively or additionally, the one or more first consumers or the one or more second consumers may include a controller of the communication network devices.

Moreover, a given token of the tokens may include a JavaScript Object Notation (JSON) Web Token.

Furthermore, the first format may include a key-value-pair format and the second format may include a protocol buffer (such as a Google protocol buffer).

Additionally, the computer system may not receive the state messages from a controller of the communication network devices.

In some embodiments, the computer system may receive the state messages using a gRPC remote procedure call or a hypertext transfer protocol (HTTP)/2.

Note that the computer system may provide state information associated with clients in the network to an analytical service. Alternatively, the computer system may receive the state information associated with the clients from the analytical service.

Moreover, the computer system may receive information indicating the type of event from an analytical service.

Furthermore, the report messages may include operating statistics during time intervals or reports during the time intervals, where the report messages are associated with the communication network devices and/or clients that are associated or connected to the communication network devices.

Additionally, the event messages may include status information associated with the communication network devices. For example, an event message may indicate that a given communication network device was rebooted.

In some embodiments, the computer system may compute, based at least in part on the report messages, a number of clients connected to or associated with the network or a rate of the state messages from the network. The computer system may store, in memory, the number of the communication network devices in the network or the rate of the state messages the network.

Another embodiment provides a computer-readable storage medium with program instructions for use with the computer system. When executed by the computer system, the program instructions cause the computer system to perform at least some of the aforementioned operations in one or more of the preceding embodiments.

Another embodiment provides a method, which may be performed by the computer system. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for processing state messages using a computer system in FIG. 1 in accordance with an embodiment of the present disclosure.

FIG. 3 is a drawing illustrating an example of communication among an access point, a computer system, a controller and an analytical service in FIG. 1 in accordance with an embodiment of the present disclosure.

FIG. 4 is a drawing illustrating an example of a computer system in accordance with an embodiment of the present disclosure.

FIG. 5 is a drawing illustrating an example of processing of report messages in accordance with an embodiment of the present disclosure.

FIG. 6 is a drawing illustrating an example of processing of event messages in accordance with an embodiment of the present disclosure.

FIG. 7 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that processes state messages is described. During operation, the computer system may receive, associated with communication network devices in a network, the state messages, where the state messages include report messages and event messages. Then, the computer system may validate the state messages based at least in part on tokens associated with the state messages. Moreover, the computer system may provide the report messages to one or more first consumers in the computer system. Furthermore, the computer system may select a subset of the event messages based at least in part on a type of event. Next, the computer system may translate the selected subset of the event messages from a first format to a second format. Additionally, the computer system may provide the translated subset of the event messages to one or more second consumers.

By performing these operations, these communication techniques may facilitate processing of the state messages by the one or more first consumers and the one or more second consumers. Notably, the communication techniques may provide a flexible and scalable architecture that allows consumers, such as an analytical service and/or a controller of the communication network devices, to reliably obtain operating statistics, reports and events associated with the communication network devices and the network. Consequently, the communication techniques may facilitate monitoring and management of the communication network devices and the network. Therefore, the communication techniques may increase the satisfaction of users of the network and/or the computer system, such as network operators or administrators and/or customers.

In the discussion that follows, electronic devices or components in a system communicate packets in accordance with a wireless communication protocol, such as: a wireless communication protocol that is compatible with an IEEE 802.11 standard (which is sometimes referred to as from the Wi-Fi Alliance of Austin, Tex.), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

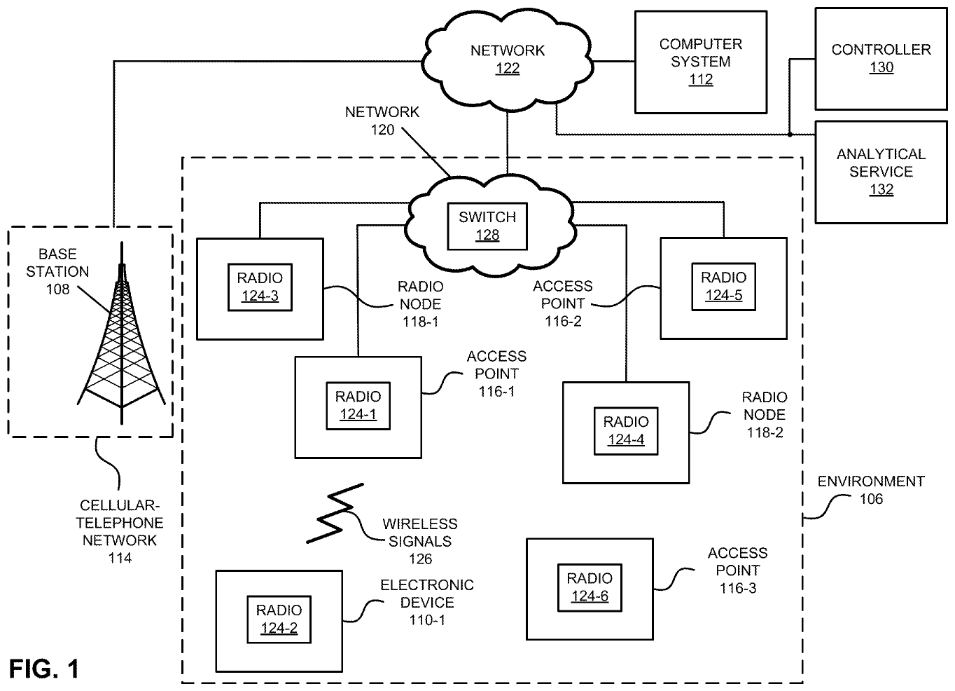

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LIE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 and/or controller 130 (which may be a local or a cloud-based controller that manages and/or configures access points 116, radio nodes 118 and/or switch 128, or that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

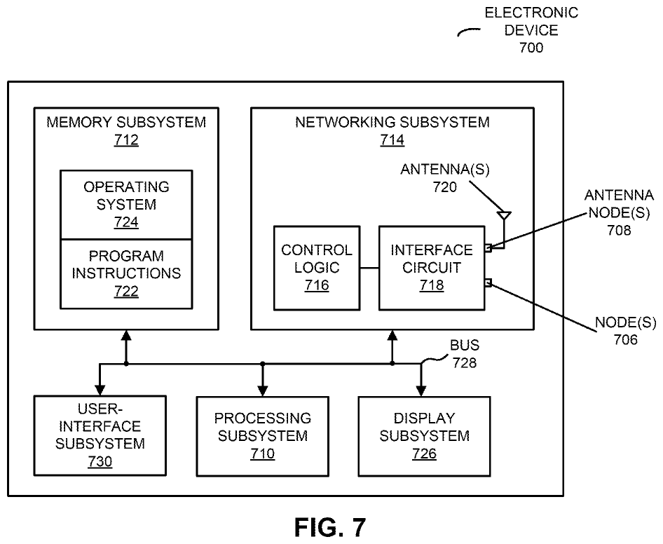

As described further below with reference to FIG. 7, electronic devices 110, computer system 112, access points 116, radio nodes 118, switch 128 and controller 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or reseed rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

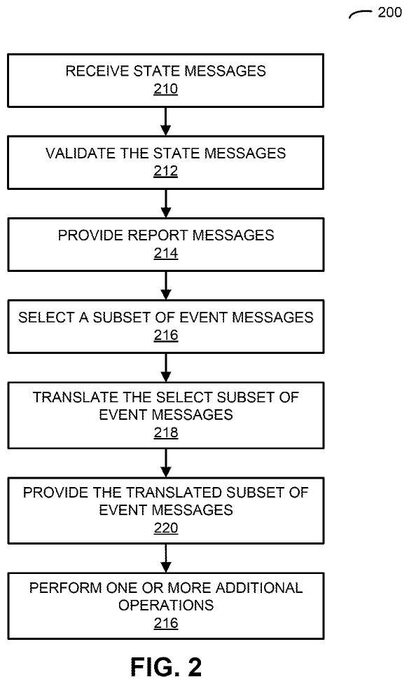

As discussed previously, it can be difficult to correctly process large numbers of state messages using a controller. Moreover, as described further below with reference to FIGS. 2-6, in order to addresses these difficulties, computer system 112 (which may include one or more computers) may implemented one or more embodiments of the communication techniques. Notably, one or more communication network devices (such as one or more access points 116, one or more radio nodes 118 and/or switch 128) may routinely provide state messages (such as report messages and/or event messages) to computer system 112. For example, the report messages may include operating statistics during time intervals or reports during the time intervals, where the report messages are associated with the communication network devices and/or clients that are associated or connected to the communication network devices. Furthermore, the event messages may include status information associated with the communication network devices. For example, an event message may indicate that a given communication network device was rebooted.

After receiving the state messages, computer system 112 may validate the state messages based at least in part on tokens associated with the state messages (such as JSON Web Tokens or tokens compatible with a Request for Comments or RFC 7519 standard). Moreover, computer system 112 may provide the report messages to one or more first consumers in the computer system (such as controller 130 and/or analytical service 132).

Furthermore, computer system 112 may select a subset of the event messages based at least in part on a type of event (which may be specified by analytical service 132). Next, computer system 112 may translate the selected subset of the event messages from a first format to a second format. For example, the first format may include a key-value-pair format and the second format may include a protocol buffer (such as a Google protocol buffer). More generally, the second format may be human readable. Additionally, computer system 112 may provide the translated subset of the event messages to one or more second consumers (such as report messages and/or event messages).

In these ways, the communication techniques may ensure that the state messages can be flexibly processed at scale. For example, the communication techniques may allow consumers, such as an analytical service and/or a controller of the communication network devices, to reliably obtain operating statistics, reports and events associated with the communication network devices and the network. Consequently, the communication techniques may facilitate monitoring and management of the communication network devices and the network.

We now describe embodiments of the method. FIG. 2 presents a flow diagram illustrating an example of a method 200 for processing state messages, which may be performed by a computer system (such as computer system 112). During operation, the computer system may receive, associated with communication network devices in a network, the state messages (operation 210), where the state messages include report messages and event messages. The report messages may include operating statistics during time intervals or reports during the time intervals, where the report messages are associated with the communication network devices and/or clients that are associated or connected to the communication network devices. Moreover, the event messages may include status information associated with the communication network devices. For example, an event message may indicate that a given communication network device was rebooted. Note that the computer system may not receive the state messages from a controller of the communication network devices. In some embodiments, the computer system may receive the state messages using a gRPC remote procedure call or HTTP/2.

Then, the computer system may validate the state messages (operation 212) based at least in part on tokens associated with the state messages. Note that a given token of the tokens may include a JSON Web Token.

Moreover, the computer system may provide the report messages (operation 214) to one or more first consumers in the computer system. For example, the one or more first consumers may include an analytical service and/or a controller of the communication network devices.

Furthermore, the computer system may select a subset of the event messages (operation 216) based at least in part on a type of event.

Next, the computer system may translate the selected subset of the event messages (operation 218) from a first format to a second format. Note that the first format may include a key-value-pair format and the second format may include a protocol buffer (such as a Google protocol buffer).

Additionally, the computer system may provide the translated subset of the event messages (operation 220) to one or more second consumers. For example, the one or more second consumers may include an analytical service and/or a controller of the communication network devices.

In some embodiments, the computer system optionally performs one or more additional operations (operation 222). For example, the computer system may provide state information associated with clients in the network to an analytical service. Alternatively, the computer system may receive the state information associated with the clients from the analytical service.

Moreover, the computer system may receive information indicating the type of event from an analytical service.

In some embodiments, the computer system may compute, based at least in part on the report messages, a number of clients connected to or associated with the network or a rate of the state messages from the network. The computer system may store, in memory, the number of the communication network devices in the network or the rate of the state messages the network.

In some embodiments of method 200, there may be additional or fewer operations. Furthermore, the order of the operations may be changed, and/or two or more operations may be combined into a single operation. For example, in some embodiments, at least some of the operations in the communication techniques may be performed by controller 130. Thus, in some embodiments, the communication techniques may be performed in a centralized and/or a distributed manner.

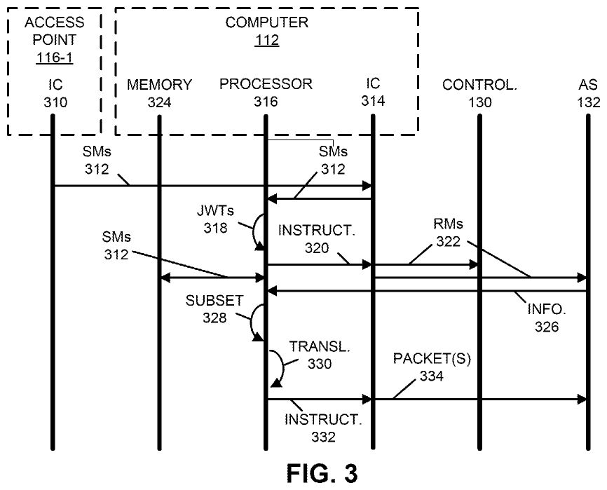

Embodiments of the communication techniques are further illustrated in FIG. 3, which presents a drawing illustrating an example of communication among access point 116-1, computer system 112, controller 130 and analytical service 132. An interface circuit (IC) 310 in access point 116-1 may provide one or more state messages (SMs) 312 to computer system 112, where the one or more state messages 312 include report messages and event messages.

After or while receiving state messages 312 from access point 116-1, an interface circuit 314 in computer system 112 may provide state messages 312 to processor 316 in computer system 112. Processor 316 may validate JSON Web Tokens (JWTs) 318 in state messages 312. Then, processor 316 may instruct 320 interface circuit 314 to provide report messages (RMs) 322 to controller 130 and/or analytical service (AS) 132 (e.g., in one or more frames or packets). In some embodiments, processor 316 may store (at least temporarily) state messages 312 in memory 324 in computer system 112.

Moreover, analytical service 132 may provide information 326 indicating or specifying a type of event that may be of interest to analytical service 132. After receiving information 326, interface circuit 314 may provide information 326 to processor 316. In response, processor 316 may select a subset 328 of event messages based at least in part on the type of event. Next, processor 316 may translate 330 the selected subset 328 of the event messages from a first format to a second format. Additionally, processor 316 may instruct 332 interface circuit 314 to provide the translated subset of the event messages to controller 130 and/or analytical service 132, e.g., in one or more frames or packets 334.

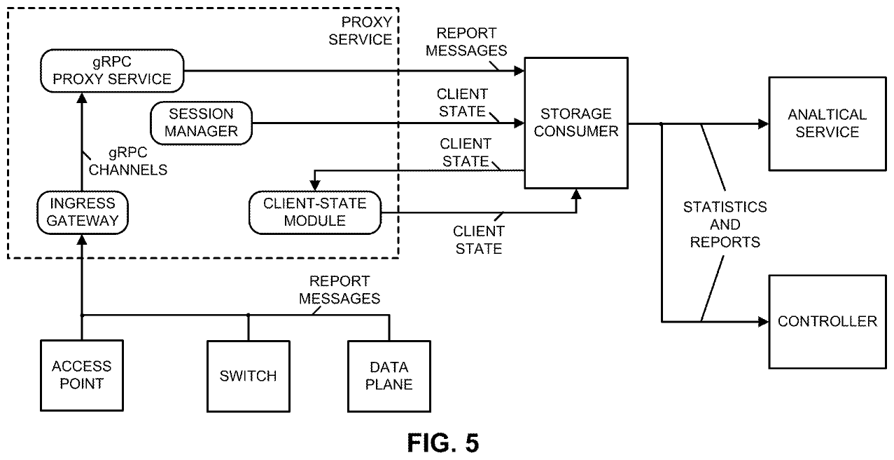

While FIG. 3 illustrates communication between components using unidirectional or bidirectional communication with lines having single arrows or double arrows, in general the communication in a given operation in this figure may involve unidirectional or bidirectional communication. Moreover, while FIG. 5 illustrates operations being performed sequentially or at different times, in other embodiments at least some of these operations may, at least in part, be performed concurrently or in parallel.

We now further describe the communication techniques. Communication network devices periodically (such as every 90 s or 180 s) or as needed report statistics and/or events. For example, the state messages may include information, such as: a number of client connections, network usage, applications being used by users (e.g., a Web browser), etc. Note that event messages may depend on client behavior (such as when a client joints or leaves a network) or may include status information associated with a given communication network device (such as when the given communication network device is rebooted).

In the communication techniques, a computer system may process these state messages. Notably, the computer system may provide a proxy service that supports different types of state messages (such as state messages with statistics and/or status reports) that are received using gRPC, HTTP/2 or another communication protocol. After validating the state messages (e.g., based at least in part on JSON Web Tokens associated with the sources of the state messages, the communication network devices), the proxy service may provide at least some of the state messages to other components deployed in the cloud (which are sometimes referred to as ‘consumers’). Furthermore, the proxy service may selectively convert event messages in the state messages into a format that is compatible with one or more consumers (such as a Google protocol buffer). (Note that a Protocol Buffer may specify a format of serialized data, as with JSON or Extensible Markup Language, but with additional characteristics.) For example, the proxy service may support white-list filtering based at least in part on a type of event or event code that is provided by an analytical service. In some embodiments, the proxy service may provide real-time data monitoring capability, e.g., to record a number of connected clients or stations and/or a rate of incoming state messages. This monitoring may allow the proxy service to be appropriately scaled.

Note that each type of state message may have a corresponding unform resource indicator (URI) instead of a super wrapper.

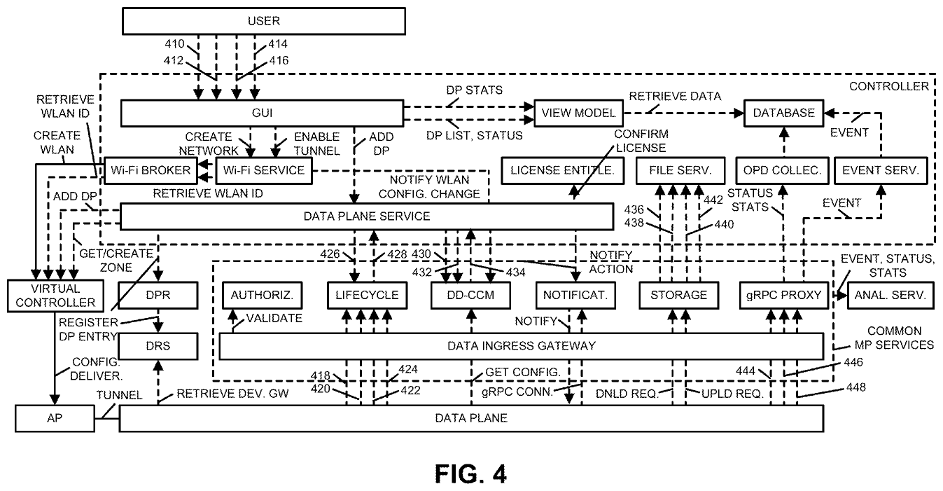

FIG. 4 presents a drawing illustrating an example of a computer system, including common management plane (MP) services and a controller. During operation, a user may, via a controller graphical user interface (GUI), provide or modify configuration information, including: add a data plane (DP) 410, create a network 412, enable a tunnel WLAN 414 and/or check data-plane lists, statistics and/or status 416. Moreover, via a device ingress gateway, a data plane may: discover JSON Web token(s) 418, establish a gRPC connection 420, provide state information 422 and/or provide a heartbeat 424. Furthermore, in response to the user's configuration information, a data-plane service may: add a data plane 426, and receive notification that the data plane is registered 428. Then, the data-plane service may: add the data plane 430, configure a change 432, and/or receive confirmation that the configuration has been generated 434. Additionally, devise storage may provide information to a file service, including: relay download 436, relay upload 438, getting a download singled uniform resource locator URL) 440, and/or getting an upload singled URL 442. The data plane may also perform operations with a gRPC proxy, including: establish a gRPC connection 444, provide status and statistics 446, and/or provide event information 448.

Moreover, FIG. 5 presents a drawing illustrating an example of processing report messages by a proxy service. Notably, one or more communication network devices may provide the report messages. For example, an access point may provide a report message with operating statistics, a switch may provide a report message with operating statistics, and/or a data plane may provide a report message with operating statistics. The report messages may be received via an ingress gateway, where the report messages may be validated based at least in part on JSON Web Tokens from gRPC headers. Then, a statistics/events gRPC proxy service may receive the report messages via gRPC channels, and may publish the report messages to one or more consumers, such as a storage consumer (e.g., a data structure or a database) that maintains records associated with the communication network devices, clients connected to or associated with the network, and/or the network. Moreover, a controller and/or an analytical service may consume the statistics and/or reports included in the report messages. Furthermore, a control plane session manager may publish client state information to the storage consumer. Additionally, a client-state module or engine may obtain the client state from the storage consumer and/or may provide the client state to the storage consumer along with optional additional information (such as a domain name, a zone identifier, an identifier of a given communication network device, etc.).

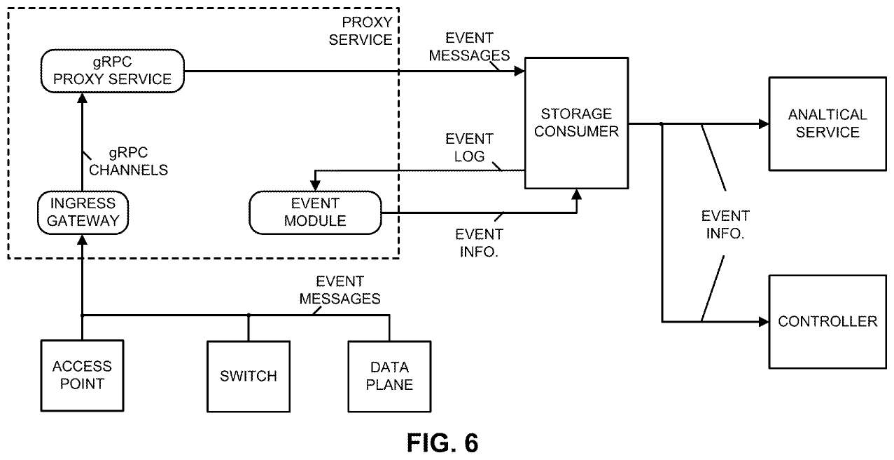

Furthermore, FIG. 6 presents a drawing illustrating an example of processing of event messages by a proxy service. Notably, one or more communication network devices may provide the event messages. For example, an access point may provide an event message with status information or configuration changes, a switch may provide an event message with status information or configuration changes, and/or a data plane may provide an event message with status information or configuration changes. The event messages may be received via an ingress gateway, where the event messages may be validated based at least in part on JSON Web Tokens from gRPC headers. Then, a statistics/events gRPC proxy service may receive the event messages via gRPC channels, and may publish the event messages to one or more consumers, such as a storage consumer (e.g., a data structure or a database) that maintains records associated with the communication network devices, clients connected to or associated with the network, and/or the network. Moreover, a controller and/or an analytical service may consume event information included in the event messages. Furthermore, an event module may obtain an event log from the storage consumer. Then, the event module or engine may filter events information in the event log based at least in part on a whitelist and/or may convert or transform the event information into a different format (such as Google protocol buffer). Next, the event module may provide the filtered and converted event information to the storage consumer.

We now describe embodiments of an electronic device, which may perform at least some of the operations in the communication techniques. FIG. 7 presents a block diagram illustrating an example of an electronic device 700 in accordance with some embodiments, such as one of: base station 108, one of electronic devices 110, computer system 112, one of access points 116, one of radio nodes 118, switch 128 or controller 130. This electronic device includes processing subsystem 710, memory subsystem 712, and networking subsystem 714. Processing subsystem 710 includes one or more devices configured to perform computational operations. For example, processing subsystem 710 can include one or more microprocessors, graphics processing units (GPUs), ASICs, microcontrollers, programmable-logic devices, and/or one or more digital signal processors (DSPs).

Memory subsystem 712 includes one or more devices for storing data and/or instructions for processing subsystem 710 and networking subsystem 714. For example, memory subsystem 712 can include DRAM, static random access memory (SRAM), and/or other types of memory. In some embodiments, instructions for processing subsystem 710 in memory subsystem 712 include: one or more program modules or sets of instructions (such as program instructions 722 or operating system 724, such as Linux, UNIX, Windows Server, or another customized and proprietary operating system), which may be executed by processing subsystem 710. Note that the one or more computer programs, program modules or instructions may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718 and one or more antennas 720 (or antenna elements). (While FIG. 7 includes one or more antennas 720, in some embodiments electronic device 700 includes one or more nodes, such as antenna nodes 708, e.g., a metal pad or a connector, which can be coupled to the one or more antennas 720, or nodes 706, which can be coupled to a wired or optical connection or link. Thus, electronic device 700 may or may not include the one or more antennas 720. Note that the one or more nodes 706 and/or antenna nodes 708 may constitute input(s) to and/or output(s) from electronic device 700.) For example, networking subsystem 714 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 700 may be adapted or changed using pattern shapers (such as directors or reflectors) and/or one or more antennas 720 (or antenna elements), which can be independently and selectively electrically coupled to ground to steer the transmit antenna pattern in different directions. Thus, if one or more antennas 720 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 700 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 700 may use the mechanisms in networking subsystem 714 for performing simple wireless communication between the electronic devices, e.g., transmitting advertising or beacon frames and/or scanning for advertising frames transmitted by other electronic devices as described previously.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc.

Moreover, electronic device 700 may include a user-interface subsystem 730, such as: a mouse, a keyboard, a trackpad, a stylus, a voice-recognition interface, and/or another human-machine interface. In some embodiments, user-interface subsystem 730 may include or may interact with a touch-sensitive display in display subsystem 726.

Electronic device 700 can be (or can be included in) any electronic device with at least one network interface. For example, electronic device 700 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or display subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments some or all of a given subsystem or component can be integrated into one or more of the other subsystems or component(s) in electronic device 700. For example, in some embodiments instructions 722 is included in operating system 724 and/or control logic 716 is included in interface circuit 718.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 714 and/or of electronic device 700. The integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 722, operating system 724 (such as a driver for interface circuit 718) or in firmware in interface circuit 718. Alternatively or additionally, at least some of the operations in the communication techniques may be implemented in a physical layer, such as hardware in interface circuit 718.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with communication network devices in a network, wherein the computer system is configured to:
receive, associated with the communication network devices, the state messages, wherein the state messages comprise report messages and event messages;
validate the state messages based at least in part on tokens associated with the state messages;
provide the report messages to one or more first consumers in the computer system;
select a subset of the event messages based at least in part on a type of event;
translate the selected subset of the event messages from a first format to a second format; and
provide the translated subset of the event messages to one or more second consumers.

2. The computer system of claim 1, wherein the one or more first consumers or the one or more second consumers comprise an analytical service.

3. The computer system of claim 1, wherein the one or more first consumers or the one or more second consumers comprise a controller of the communication network devices.

4. The computer system of claim 1, wherein a given token of the tokens comprises a JavaScript Object Notation (JSON) Web Token.

5. The computer system of claim 1, wherein the first format comprises a key-value-pair format and the second format comprises a protocol buffer.

6. The computer system of claim 1, wherein the computer system does not receive the state messages from a controller of the communication network devices.

7. The computer system of claim 1, wherein the computer system receives the state messages using a gRPC remote procedure call or a hypertext transfer protocol (HTTP)/2.

8. The computer system of claim 1, wherein the computer system is configured to provide state information associated with clients in the network to an analytical service.

9. The computer system of claim 1, wherein the computer system is configured to receive the state information associated with the clients from the analytical service.

10. The computer system of claim 1, wherein the computer system is configured to receive information indicating the type of event from an analytical service.

11. The computer system of claim 1, wherein the report messages comprise operating statistics or reports during time intervals; and
wherein the operating statistics and the reports are associated with: the communication network devices, clients that are associated or connected to the communication network devices or both.

12. The computer system of claim 1, wherein the event messages comprise status information associated with the communication network devices.

13. The computer system of claim 1, wherein the computer system is configured to compute, based at least in part on the report messages, a number of clients connected to or associated with the network or a rate of the state messages from the network.

14. A non-transitory computer-readable storage medium for use in conjunction with a computer system, the computer-readable storage medium storing program instructions that, when executed by the computer system, cause the computer system to perform operations comprising:
receiving, associated with communication network devices in a network, the state messages, wherein the state messages comprise report messages and event messages;
validating the state messages based at least in part on tokens associated with the state messages;
providing the report messages to one or more first consumers in the computer system;
selecting a subset of the event messages based at least in part on a type of event;
translating the selected subset of the event messages from a first format to a second format; and
providing the translated subset of the event messages to one or more second consumers.

15. The non-transitory computer-readable storage medium of claim 14, wherein the one or more first consumers or the one or more second consumers comprise a controller of the communication network devices.

16. The non-transitory computer-readable storage medium of claim 14, wherein the operations comprise receiving information indicating the type of event from an analytical service.

17. A method for processing state messages, comprising:
by a computer system:
receiving, associated with communication network devices in a network, the state messages, wherein the state messages comprise report messages and event messages;
validating the state messages based at least in part on tokens associated with the state messages;
providing the report messages to one or more first consumers in the computer system;
selecting a subset of the event messages based at least in part on a type of event;
translating the selected subset of the event messages from a first format to a second format; and
providing the translated subset of the event messages to one or more second consumers.

18. The method of claim 17, wherein the one or more first consumers or the one or more second consumers comprise a controller of the communication network devices.

19. The method of claim 17, wherein a given token of the tokens comprises a JavaScript Object Notation (JSON) Web Token.

20. The method of claim 17, wherein the method comprises receiving information indicating the type of event from an analytical service.
